(19) United States
(12) Patent Application Publication
(10) Pub. No.: US 2023/0307854 A1
(43) Pub. Date: Sep. 28, 2023

(54) SYSTEM AND METHODS FOR COUPLING A CONNECTOR TO CIRCUIT BOARD AND CABLE

(71) Applicant: Dell Products L.P., Round Rock, TX (US)

(72) Inventors: Jason PRITCHARD, Hopkinton, MA (US); Stephen STRICKLAND, Foxborough, MA (US)

(73) Assignee: Dell Products L.P., Round Rock, TX (US)

(21) Appl. No.: 17/704,999

(22) Filed: Mar. 25, 2022

(51) Int. Cl. H01R 12/55; H01R 4/02

(52) U.S. Cl. CPC H01R 12/55; H01R 4/023

(57) ABSTRACT

A circuit board assembly may include a circuit board, a connector electrically and mechanically coupled to the circuit board and comprising at least one circuit board pin extending from the connector, each circuit board pin electrically coupled to a corresponding electrical trace within the circuit board, and at least one cable termination pad, each cable termination pad configured to be electrically and mechanically soldered to a corresponding wire of a cable.

### TECHNICAL FIELD

The present disclosure relates in general to information handling systems, and more particularly to systems and methods for coupling a termination of a cable to a circuit board and a connector of the circuit board.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

In many applications, one or multiple information handling servers may be installed within a single chassis, housing, enclosure, or rack. Communication between or within servers and/or between enclosures may often be accomplished via cables, and many communications standards and protocols employ a copper cable implementation for signaling.

As signal speeds increase with each new generation of information handling system, it becomes increasingly necessary to improve electrical performance of cables, to enable faster speeds, longer cables, and reliable signal transmission. In many implementations, cable wires are coupled to circuit board traces on a surface of the circuit board, wherein the traces are interfaced between terminations of the cable wires and a connector of the circuit board. However, such traces between cable termination and circuit board connector may negatively impact signal quality.

### SUMMARY

In accordance with the teachings of the present disclosure, the disadvantages and problems associated with traditional approaches to electrical coupling of cables to a circuit board and associated connector may be substantially reduced or eliminated.

In accordance with embodiments of the present disclosure, a circuit board assembly may include a circuit board, a connector electrically and mechanically coupled to the circuit board and comprising at least one circuit board pin extending from the connector, each circuit board pin electrically coupled to a corresponding electrical trace within the circuit board, and at least one cable termination pad, each cable termination pad configured to be electrically and mechanically soldered to a corresponding wire of a cable.

In accordance with these and other embodiments of the present disclosure, an information handling system may include an information handling resource, a cable, and a circuit board assembly comprising a circuit board, a connector electrically and mechanically coupled to the circuit board and comprising at least one circuit board pin extending from the connector, each circuit board pin electrically coupled to a corresponding electrical trace within the circuit board and configured to electrically couple the corresponding electrical trace to the information handling resource via the connector, and at least one cable termination pad, each cable termination pad configured to be electrically and mechanically soldered to a corresponding wire of the cable.

In accordance with these and other embodiments of the present disclosure, a method may include electrically and mechanically coupling a circuit board to a connector having at least one circuit board pin extending from the connector, each circuit board pin electrically coupled to a corresponding electrical trace within the circuit board, and at least one cable termination pad, each cable termination pad configured to be electrically and mechanically soldered to a corresponding wire of a cable.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a system comprising a plurality of chassis, each chassis comprising at least one information handling system, in accordance with embodiments of the present disclosure; and

FIG. 2 illustrates an isometric view of a circuit board with a hybrid connector that enables coupling of a cable to both pads of a circuit board and to pins on the connector, in accordance with embodiments of the present disclosure.

### DETAILED DESCRIPTION

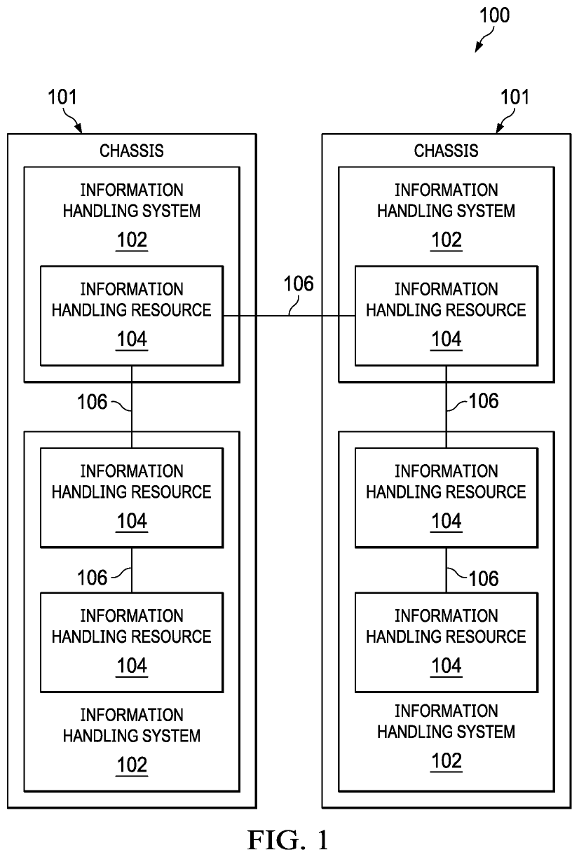

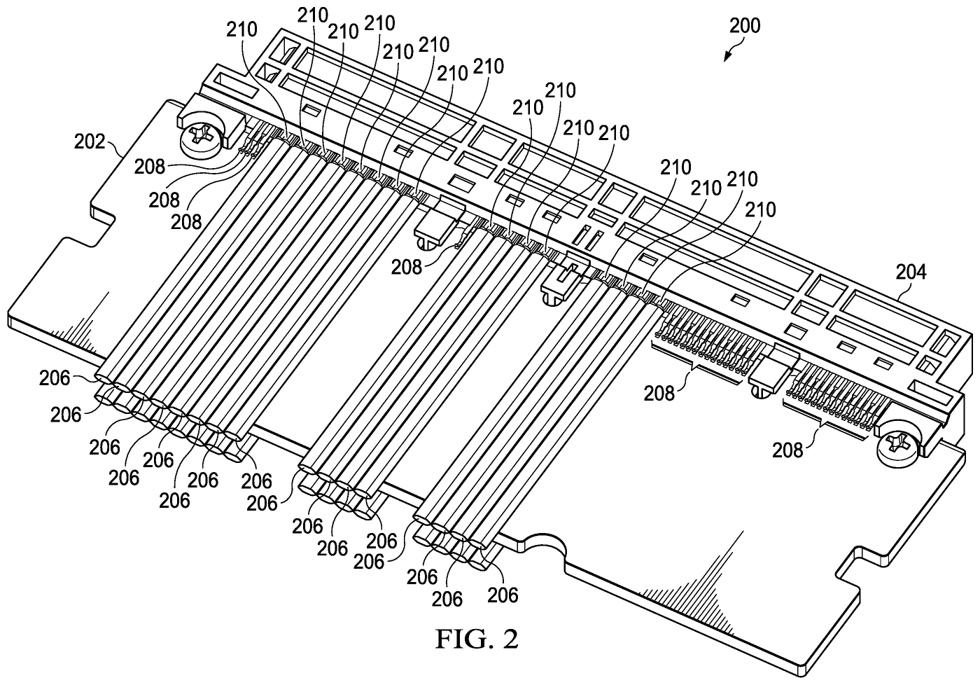

Preferred embodiments and their advantages are best understood by reference to FIGS. 1 and 2, wherein like numbers are used to indicate like and corresponding parts.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

For the purposes of this disclosure, information handling resources may broadly refer to any component system, device or apparatus of an information handling system, including without limitation processors, service processors, basic input/output systems, buses, memories, I/O devices and/or interfaces, storage resources, network interfaces, motherboards, air movers, sensors, power supplies, and/or any other components and/or elements of an information handling system.

FIG. 1 illustrates a system 100 comprising a plurality of chassis 101, each chassis 101 comprising at least one information handling system 102, in accordance with embodiments of the present disclosure. Each chassis 101 may be an enclosure that serves as a container for various information handling systems 102 and information handling resources 104, and may be constructed from steel, aluminum, plastic, and/or any other suitable material. Although the term “chassis” is used, a chassis 101 may also be referred to as a case, cabinet, tower, box, enclosure, and/or housing. In certain embodiments, a chassis 101 may be configured to hold and/or provide power to one or more information handling systems 102 and/or information handling resources 104.

In some embodiments, one or more of information handling systems 102 may comprise servers. For example, in some embodiments, information handling systems 102 may comprise rack servers and each chassis 101 may comprise a rack configured to house such rack servers. As shown in FIG. 1, each information handling system 102 may include one or more information handling resources 104. An information handling resource 104 may include any component system, device or apparatus of an information handling system 102, including without limitation processors, service processors, basic input/output systems, buses, memories, I/O devices and/or interfaces, storage resources, network interfaces, motherboards, air movers, sensors, power supplies, and/or any other components and/or elements of an information handling system. For example, in some embodiments, an information handling resource 104 of an information handling system 102 may comprise a processor. Such processor may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, a processor may interpret and/or execute program instructions and/or process data stored in a memory and/or another information handling resource of an information handling system 102.

In these and other embodiments, an information handling resource 104 of an information handling system 102 may comprise a memory. Such a memory may be communicatively coupled to an associated processor and may include any system, device, or apparatus configured to retain program instructions and/or data for a period of time (e.g., computer-readable media). A memory may include RAM, EEPROM, a PCMCIA card, flash memory, magnetic storage, opto-magnetic storage, or any suitable selection and/or array of volatile or non-volatile memory that retains data after power to an associated information handling system 102 is turned off.

In addition to a processor and/or a memory, an information handling system 102 may include one or more other information handling resources.

As shown in FIG. 1, information handling resources 104 may be communicatively coupled to each other via a cable 106, whether such information handling resources 104 are within different information handling systems 102 in the same chassis 101, are in different chassis 101, or are in the same information handling system 102. A cable 106 may include any suitable assembly of two or more electrically-conductive wires running side by side to carry one or more signals between information handling resources.

FIG. 2 illustrates an isometric view of a circuit board assembly 200 having a circuit board 202 and a hybrid connector 204, in accordance with embodiments of the present disclosure. Circuit board assembly 200 or a circuit board assembly similar to circuit board assembly 200 may be used to implement at least a portion of each information handling system 102 and/or information handling resources 104. Circuit board 202 may include a plurality of pads, traces, and vias. Pads may comprise a conductive material and may be formed on a surface (e.g., top or bottom surface) of circuit board 202 or within an internal layer of circuit board 202. Further, each pad may be operable to receive a pin of an electronic component (e.g., a packaged integrated circuit) and provide electrical connectivity between the pin and one or more traces. Traces may comprise a conductive material and may be formed on a surface of circuit board 202, or in a layer of circuit board 202 not visible from the surface thereof. Further, each trace may be operable to provide conductive pathways between electronic components mounted or otherwise electrically coupled to pads. Connectivity between pads and/or traces disposed on and/or in various layers of circuit board 202 may be provided by vias.

Hybrid connector 204 may comprise any suitable system, device, or apparatus configured to electrically couple both electrical conduits of circuit board 202 (e.g., pads, traces, vias) and wires 206 of one or more cables 106 to another information handling resource via such hybrid connector 204. Accordingly, to enable electrical coupling of both electrical conduits of circuit board 202 to corresponding electrical conduits of hybrid connector 204 and wires 206 to corresponding electrical conduits of hybrid connector 204, hybrid connector 204 may include one or more circuit board termination areas, each circuit board termination area having one or more circuit board pins 208, and may include one or more cable termination areas, each cable termination area having one or more cable termination pads 210.

A circuit board pin 208 may comprise any suitable electrical conductor configured to extend from hybrid connector 204 in order to electrically couple to a corresponding trace within circuit board 202.

A cable termination pad 210 may comprise any suitable electrical conductor configured to be electrically and mechanically soldered to a corresponding wire 206 of a cable 106. Wires 206 may be electrically and mechanically coupled to their respective corresponding cable termination pads 210 via any suitable process, including without limitation a “hotbar” process, use of lasers, and/or any other suitable process.

Thus, in operation, low-speed signals and/or signals that require processing by one or more components of circuit board 202 may utilize circuit board pins 208 to communicate signals between hybrid connector 204 and such one or more components of circuit board 202, while high-speed signals that do not require processing by one or more components of circuit board 202 may utilize cable termination pads 210 to communicate signals between hybrid connector 204 and wires 206. Accordingly, such high-speed signals may experience reduced signal loss, crosstalk noise, and signal reflections and require reduced circuit board area as compared to existing approaches.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

1. A circuit board assembly comprising:
a circuit board; and
a connector electrically and mechanically coupled to the circuit board and comprising:
at least one circuit board pin extending from a side of the connector, each circuit board pin electrically coupled to a corresponding electrical trace within the circuit board; and
at least one cable termination pad extending from the side of the connector, each cable termination pad configured to be electrically and mechanically soldered to a corresponding wire of a cable.

2. The circuit board assembly of claim 1, wherein each corresponding electrical trace is communicatively coupled to a component of the circuit board assembly for processing signals carried on the corresponding electrical trace.

3. The circuit board assembly of claim 2, wherein each corresponding wire is configured to carry signals of higher speed than those carried on the corresponding electrical traces.

4. An information handling system comprising:
an information handling resource;
a cable; and
a circuit board assembly comprising:
a circuit board; and
a connector electrically and mechanically coupled to the circuit board and comprising:
at least one circuit board pin extending from a side of the connector, each circuit board pin electrically coupled to a corresponding electrical trace within the circuit board and configured to electrically couple the corresponding electrical trace to the information handling resource via the connector; and
at least one cable termination pad extending from the side of the connector, each cable termination pad configured to be electrically and mechanically soldered to a corresponding wire of the cable.

5. The information handling system of claim 4, wherein each corresponding electrical trace is communicatively coupled to a component of the circuit board assembly for processing signals carried on the corresponding electrical trace.

6. The information handling system of claim 5, wherein each corresponding wire is configured to carry signals of higher speed than those carried on the corresponding electrical traces.

7. A method comprising:
electrically and mechanically coupling a circuit board to a connector having:
at least one circuit board pin extending from a side of the connector, each circuit board pin electrically coupled to a corresponding electrical trace within the circuit board; and
at least one cable termination pad extending from the side of the connector, each cable termination pad configured to be electrically and mechanically soldered to a corresponding wire of a cable.

8. The method of claim 7, wherein each corresponding electrical trace is communicatively coupled to a component of the circuit board assembly for processing signals carried on the corresponding electrical trace.

9. The method of claim 8, wherein each corresponding wire is configured to carry signals of higher speed than those carried on the corresponding electrical traces.
